(19) United States
(12) Patent Application Publication
(10) Pub. No.: US 2009/0251496 A1
(43) Pub. Date: Oct. 8, 2009

(54) DISPLAY DEVICE AND DRIVING METHOD THEREOF

(75) Inventors: Nobuyoshi SAITO, Kawasaki-Shi (JP); Tomomasa Ueda, Yokohama-Shi (JP); Yujiro Hara, Yokohama-Shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 12/403,524

(22) Filed: Mar. 13, 2009

(30) Foreign Application Priority Data
Mar. 26, 2008 (JP) 2008-080568

(51) Int. Cl. G09G 5/10

(52) U.S. Cl. 345/690

(57) ABSTRACT

This disclosure concerns a display device including: scanning lines; data lines; a drive transistor controlling a current through a light emitting element; a bias transistor connected between a gate of the drive transistor and a first signal line transmitting a negative bias lower than a potential of the second power supply; a Vt detection transistor setting a threshold voltage of the drive transistor; a capacitor applying a potential difference between gate-source of the drive transistor; a scanning transistor setting a potential of the data line to the second electrode; a scanning line driver; and a data line driver transmitting potential data to the pixel columns, wherein before setting the threshold voltage to the first electrode, the bias transistor connects the first signal line to the gate of the drive transistor and applies the negative bias to the gate of the drive transistor.

### CROSS-REFERENCE TO RELATED APPLICATION

This application is based upon and claims the benefit of priority from the prior Japanese Patent Application No. 2008-80568, filed on Mar. 26, 2008, the entire contents of which are incorporated herein by reference.

### BACKGROUND OF THE INVENTION

1. Field of the Invention

The present invention relates to a display device and a display device driving method.

2. Related Art

Recently, attention has been paid to an organic electroluminescence (EL) display device using OLEDs (Organic light emitting diodes) that are self-luminous element as a flat display device. Since the EL display device includes the self-luminous organic EL elements, it is unnecessary to provide a backlight necessary for a liquid crystal display device. Further, the EL display device has features suited for reproducing moving images, that is, a wide image view angle and a quick response.

However, the organic EL display device has the following problems. Since the OLED is a current-driven self-luminous element, a drive TFT (Thin Film Transistor) applying a current to the OLED needs to be normally in an ON-state if display of a pixel is to be kept. Due to this, with passage of time, mobility of the drive TFT deteriorates and a threshold voltage Vth of the drive TFT rises. These deteriorations in characteristics of the drive TFT change a drive current for driving the OLED while the drive TFT operates. If the drive current for the OLED changes, irregular brightnesses of pixels and afterimage (burn-in) on screen display occur while the organic EL display device operates. If a TFT formed out of low crystallinity silicon such as amorphous silicon (a-Si) is adopted as the drive TFT, the threshold voltage Vth of the drive TFT is considerably greatly shifted. Due to this, it is still difficult to put the OLED display device using the a-Si drive TFTs to practical use. Furthermore, there has been lately proposed a pixel circuit configured so that a low temperature polycrystalline polysilicon TFT is used as each drive TFT to make it possible to quickly detect the threshold voltage of the drive TFT. However, the drive TFT constituted by such a low temperature polycrystalline polysilicon TFT has the same problem of threshold voltage shift.

To deal with the problem, there is known a technique for incorporating a compensation circuit compensating for the threshold voltage shift of the drive TFT into each pixel (Non-Patent Document 1). According to this technique, a threshold voltage compensation period is set separately from light emitting time, and a gate and a drain of the drive TFT is diode-connected and a gate potential of the drive TFT is discharged during the threshold voltage compensation period. As a result, the threshold voltage of the drive TFT is stored as a voltage of a retention capacity. However, because of the use of a discharge phenomenon of the gate potential of the drive TFT, it disadvantageously takes longer time to detect the threshold voltage. For this reason, the display device having the compensation circuit incorporated in each pixel is not suited for a large-sized, high-definition display.

Furthermore, to deal with the threshold voltage shift of the drive TFT, there is known a technique for providing a circuit applying a negative bias to a gate of the drive TFT per pixel and providing a signal line dedicated to application of the negative bias per row, as described in Non-Patent Document 2. However, to provide the additional circuit per pixel and to provide the dedicated signal line per row make it difficult to lay out an image region and prevent realization of a high-definition display.

### SUMMARY OF THE INVENTION

A display device including a pixel array including a plurality of display pixels including current-driven light emitting elements according to an embodiment of the present invention, comprises: a plurality of scanning lines provided to correspond to pixel rows of the pixel array, respectively; a plurality of data lines provided to correspond to pixel columns of the pixel array, respectively; an N-type drive transistor controlling a current carried from a first power supply to a second power supply via the light emitting element; a bias transistor connected between a gate of the drive transistor and a first signal line, the first signal line transmitting a negative bias lower than a potential of the second power supply; a Vt detection transistor connected between a gate of the bias transistor and a drain of the drive transistor, and setting a threshold voltage of the drive transistor to the gate of the bias transistor; a capacitor having a first electrode connected to the gate of the drive transistor, and applying a potential difference between the gate of the drive transistor and a source of the drive transistor when the light emitting element is driven to emit light; a scanning transistor connected between a second electrode of the capacitor and the data line corresponding to a selected pixel column among the plurality of data lines, and setting a potential of the data line corresponding to the selected pixel column to the second electrode; a scanning line driver applying a potential to the plurality of scanning lines and the first signal line; and a data line driver transmitting potential data to the plurality of pixel columns via the plurality of data lines, respectively, the potential data for driving the light emitting element to emit the light at a desired brightness and at a desired gradation, wherein

before setting the threshold voltage to the first electrode, the bias transistor connects the first signal line to the gate of the drive transistor and applies the negative bias to the gate of the drive transistor.

A display device including a pixel array including a plurality of display pixels including current-driven light emitting elements according to an embodiment of the present invention, comprises: a plurality of scanning lines provided to correspond to pixel rows of the pixel array, respectively; a plurality of data lines provided to correspond to pixel columns of the pixel array, respectively; an N-type drive transistor controlling a current carried from a first power supply to a second power supply via the light emitting element; a bias transistor connected between a gate of the drive transistor and a first signal line, the first signal line transmitting a negative bias lower than a potential of the second power supply; a Vt detection transistor connected between a gate of the bias transistor and a drain of the drive transistor, and setting a threshold voltage of the drive transistor to the gate of the bias transistor; a capacitor having a first electrode connected to the gate of the drive transistor, and applying a potential difference between the gate of the drive transistor and a source of the drive transistor when the light emitting element is driven to emit light; a scanning transistor connected between a second electrode of the capacitor and the data line corresponding to a selected pixel column among the plurality of data lines, and setting a potential of the data line corresponding to the selected pixel column to the second electrode; a scanning line driver applying a potential to the plurality of scanning lines; a data line driver transmitting potential data to the plurality of pixel columns via the plurality of data lines, respectively, the potential data for driving the light emitting element to emit the light at a desired brightness and at a desired gradation; a reset line activated when a potential of the drain of the driver transistor is reset; a reset line driver applying a potential to the reset line and the first signal line; and a reset transistor connected between the drain of the driver transistor and a first power supply, and resetting the potential of the drain of the driver transistor, wherein

before setting the threshold voltage to the first electrode, the bias transistor connects the first signal line to the gate of the drive transistor and applies the negative bias to the gate of the drive transistor, and

the reset line drive sets the threshold voltage to the first electrode by raising a potential of the first electrode from the negative bias to a higher potential than the threshold voltage of the drive transistor.

A method of driving a display device including a pixel array including a plurality of display pixels including current-driven light emitting elements according to an embodiment of the present invention,

the display device including: a plurality of scanning lines provided to correspond to pixel rows of the pixel array, respectively; a plurality of data lines provided to correspond to pixel columns of the pixel array, respectively; an N-type drive transistor controlling a current carried from a first power supply to a second power supply via the light emitting element; a bias transistor connected between a gate of the drive transistor and a first signal line, the first signal line transmitting a negative bias lower than a potential of the second power supply; a Vt detection transistor connected between a gate of the bias transistor and a drain of the drive transistor; a capacitor having a first electrode connected to the gate of the drive transistor; a scanning transistor connected between a second electrode of the capacitor and the data line corresponding to a selected pixel column out of the plurality of data lines; a scanning line driver applying a potential to the plurality of scanning lines and the first signal line; and a data line driver transmitting potential data to the plurality of pixel columns via the plurality of data lines, respectively, the potential data for driving the light emitting element to emit the light at a desired brightness and at a desired gradation,

the method comprises:

connecting the first signal line to the gate of the drive transistor, and applying the negative bias to the gate of the drive transistor;

setting the threshold voltage to the first electrode by raising a potential of the first electrode from the negative bias to a higher potential than the threshold voltage of the drive transistor;

connecting the data line corresponding to the selected pixel column to the second electrode, and setting the potential of the data line corresponding to the selected pixel column to the second electrode; and

applying a current according to a potential difference between the first electrode and the second electrode of the capacitor to the light emitting element to drive the light emitting element to emit the light.

A method of driving a display device including a pixel array including a plurality of display pixels including current-driven light emitting elements according to an embodiment of the present invention,

the display device including: a plurality of scanning lines provided to correspond to pixel rows of the pixel array, respectively; a plurality of data lines provided to correspond to pixel columns of the pixel array, respectively; an N-type drive transistor controlling a current carried from a first power supply to a second power supply via the light emitting element; a bias transistor connected between a gate of the drive transistor and a first signal line, the first signal line transmitting a negative bias lower than a potential of the second power supply; a Vt detection transistor connected between a gate of the bias transistor and a drain of the drive transistor; a capacitor having a first electrode connected to the gate of the drive transistor; a scanning transistor connected between a second electrode of the capacitor and the data line corresponding to a selected pixel column out of the plurality of data lines; a scanning line driver applying a potential to the plurality of scanning lines; a data line driver transmitting potential data to the plurality of pixel columns via the plurality of data lines, respectively, the potential data for driving the light emitting element to emit the light at a desired brightness and at a desired gradation; a reset line activated when a potential of the drain of the driver transistor is reset; a reset line driver applying a potential to the reset line and the first signal line; and a reset transistor connected between the drain of the driver transistor and a first power supply, and resetting the potential of the drain of the driver transistor,

the method comprises:

connecting the first signal line to the gate of the drive transistor, and applying the negative bias to the gate of the drive transistor;

setting the threshold voltage to the first electrode by raising a potential of the first electrode from the negative bias to a higher potential than the threshold voltage of the drive transistor;

connecting the data line corresponding to the selected pixel column to the second electrode, and setting the potential of the data line corresponding to the selected pixel column to the second electrode; and

applying a current according to a potential difference between the first electrode and the second electrode of the capacitor to the light emitting element to drive the light emitting element to emit the light.

### BRIEF DESCRIPTION OF THE DRAWINGS

FIG. 1 is a circuit diagram showing a display device according to a first embodiment;

FIG. 2 is a timing chart showing an operation of the display device according to the first embodiment;

FIG. 3 is a circuit diagram showing a display device according to a second embodiment; and

FIG. 4 is a timing chart showing an operation of the display device according to the second embodiment.

### DETAILED DESCRIPTION OF THE INVENTION

Embodiments of the present invention will be explained below in detail with reference to the accompanying drawings. Note that the invention is not limited thereto.

### First Embodiment

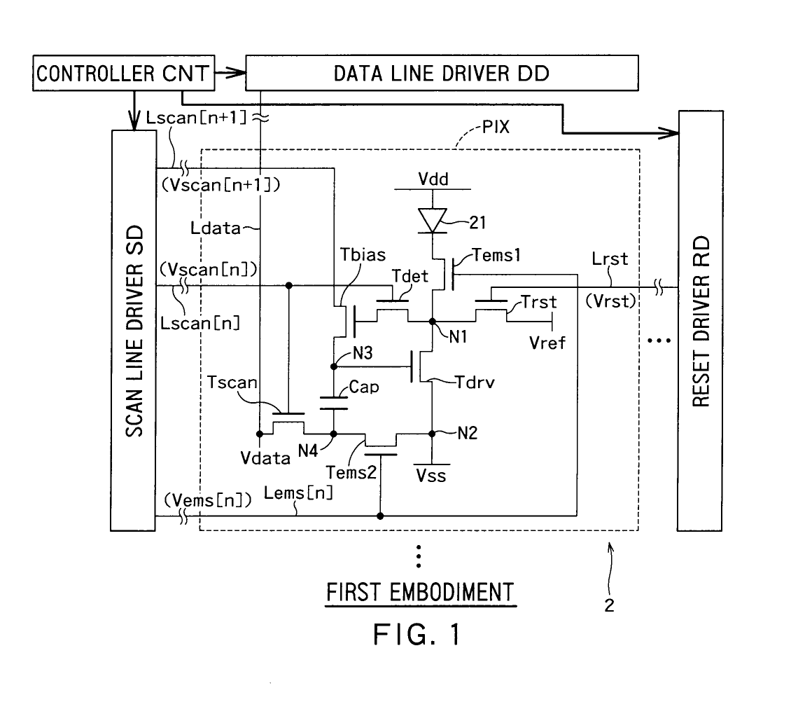

A display device according to a first embodiment of the present invention shown in FIG. 1 is an active matrix display device. The display device includes a pixel array unit 2, a data line driver DD, a scanning line driver SD, and a controller CNT synchronized with the data line drier DD and the scanning line driver SD.

Although FIG. 1 shows only one display pixel PIX, the pixel array unit 2 actually includes a plurality of display pixels PIXs arranged two-dimensionally in a matrix. Each display pixel PIX includes a light emitting element 21 constituted by an OLED, a drive transistor Tdrv, two switching elements Tems1 and Tems2, a reset transistor Trst, a Vt detection transistor Tdet, a bias transistor Tbias, a capacitor Cap, and a scanning transistor Tscan.

The light emitting element 21, the first switching element Tems1, and the drive transistor Tdrv are connected in series between a first power supply Vdd and a second power supply Vss and constitute a current path. A current carried on this current path causes the light emitting element 21 to emit light. The drive transistor Tdrv is an N-type TFT (Thin Film Transistor) at least a channel part of which is formed out of amorphous silicon. The drive transistor Tdrv controls the current carried on the current path between the first power supply Vdd and the second power supply Vss. The drive transistor Tdrv can thereby drive the light emitting element 21 to emit light at a desired brightness and a desired gradation based on potential data received from the data line driver DD. It is assumed that a drain-side node of the drive transistor Tdrv is N1, a source-side node thereof is N2, and that a gate-side node thereof is N3.

An anode of the light emitting element 21 is connected to the first power supply Vdd and a cathode thereof is connected to a drain of the first switching element Tems1. A source of the first switching element Tems1 is connected to the node N1. Namely, the first switching element Tems1 is connected between the light emitting element 21 and a drain of the drive transistor Tdrv.

The Vt detection transistor Tdet is connected between the node N1 and a gate of the bias transistor Tbias and used to detect a threshold voltage of the drive transistor Tdrv. A gate of the Vt detection transistor Tdet is connected to a first scanning line Lscan[n], where n is an integer.

The bias transistor Tbias is connected between a second scanning line Lscan[n+1] and the node N3. The bias transistor Tbias is connected to the node N1 if the Vt detection transistor Tdet is conductive, and transmits a potential of the second scanning line Lscan[n+1] to the node N3 according to a potential of the node N1.

The reset transistor Trst is connected between the node N1 and a third power supply Vref. A gate of the reset transistor Trst is connected to a reset line driver RD. A reset line Lrst is connected to the gate of the reset transistor Trst from the reset line driver RD. The reset line driver RD controls the reset transistor Trst via the reset line Lrst. The third power supply Vref has a higher potential than at least a threshold voltage of the bias transistor Tbias.

The first and second scanning lines Lscan[n] and Lscan[n+1] are connected to the scanning line driver SD, and each of the first and second scanning lines Lscan[n] and Lscan[n+1] is provided to correspond to each of pixel rows of the pixel array unit 2. If the corresponding pixel row is to be driven, a potential of each of the first and second scanning lines Lscan[n] and Lscan[n+1] is raised to a positive potential (e.g., +10 volts (V)). In a standby state where the corresponding pixel row is not driven, the potential of each of the first and second scanning lines Lscan[n] and Lscan[n+1] is kept to a negative potential (e.g., −10 V). The first and second scanning lines Lscan[n] and Lscan[n+1] are selected (activated) in order of Lscan[n] and Lscan[n+1].

Note that “activation” means turning on or driving an element or a circuit and that “deactivation” means turning off or stopping an element or a circuit. Accordingly, a HIGH (high level potential) signal is an activation signal on one occasion and a LOW (low level potential) signal is an activation signal on another occasion. For example, an NMOS transistor is activated by making a gate thereof HIGH. A PMOS transistor is activated by making a gate thereof LOW.

A first electrode and a second electrode of the capacitor Cap are connected to the node N3 and a node N4, respectively. Namely, the capacitor Cap interposes between the gate (N3) and the source (N2) of the drive transistor Tdrv. The second switching element Tems2 is connected between the nodes N4 and N2. Namely, the second switching element Tems2 is connected between the electrode on one end of the capacitor Cap and the source of the drive transistor Tdrv. The scanning transistor Tscan is connected between the node N4 and a data line Ldata propagating data. The capacitor Cap applies a potential difference between the gate (N3) and the source (N2) of the drive transistor Tdrv if the light emitting element 21 is driven to emit light.

The data line Ldata is connected to the data line driver DD and provided to correspond to each of pixel columns of the pixel array unit 2. The data line Ldata transmits potential data for driving the light emitting element 21 to emit light at the desired brightness and the desired gradation to the corresponding pixel column.

Gates of the Vt detection transistor Tdet and the scanning transistor Tscan are connected to the first scanning line Lscan[n] selecting the display pixel PIX including the Vt detection transistor Tdet and the scanning transistor Tscan in common. Accordingly, the Vt detection transistor Tdet and the scanning transistor Tscan operate at the same timing.

The first and second switching elements Tems1 and Tems2 are controlled by a signal Vems propagated on a switching line Lems. The signal Vems is a signal activated if a current is applied to the light emitting element 21 to drive the light emitting element 21 to emit light. Namely, the first and second switching elements Tems1 and Tems2 are switches that turn conductive when the light emitting element 21 emits light at the voltage held in the capacitor Cap.

With the configuration mentioned above, the display device according to the first embodiment applies a negative potential of the second scanning line Lscan[n+1] to the gate of the drive transistor Tdrv before the potential difference for driving the light emitting element 21 to emit light is held in the capacitor Cap. It is thereby possible to return a shifted threshold voltage of the drive transistor Tdrv to an original threshold voltage Vth.

While FIG. 1 shows only the first and second scanning lines Lscan[n] and Lscan[n+1], the number of scanning lines can be larger than two. Further, while FIG. 1 shows only one data line Ldata, the number of data lines can be larger than one.

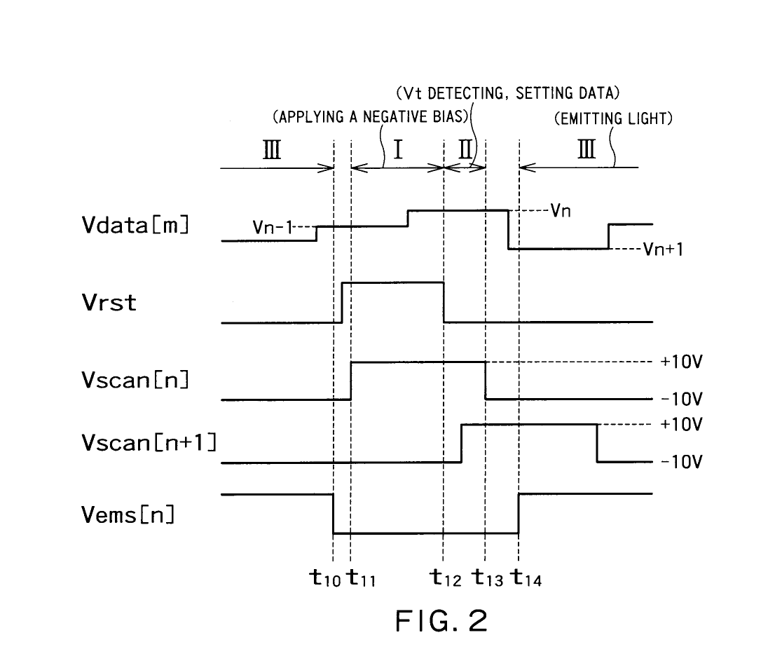

With reference to FIG. 2, an operation performed by the display device according to the first embodiment will be described. FIG. 2 shows only the operation performed by one display pixel PIX. Since operations performed by the other display pixels PIXs can be easily estimated from FIG. 2, they are not described herein.

Before t10, the scanning line driver SD selects a scanning line Lscan[n−1]. This is a state where the pixel row corresponding to the scanning line Lscan[n−1] is selected. A potential Vdata of the data line Ldata is Vn−1 and pixels PIXs corresponding to the scanning line Lscan[n−1] emit light based on the potential data Vn−1.

At this time, the first and second scanning lines Lscan[n] and Lscan[n+1] have a low level potential (−10 V). In the first embodiment, a high level potential of the scanning lines is set to +10 V. However, the potentials of the scanning lines are not limited thereto. Nevertheless, the low level potential of the scanning lines needs to be the negative potential to recover the threshold voltage Vth of the drive transistor Tdrv.

At t10, the scanning line driver SD deactivates the potential Vems[n] of the switching line Lems[n] to the low level potential. The first and second switching elements Tems1 and Tems2 are thereby turned off, and a frame selected just previously (before t10) finishes its light emitting operation.

Right after t10, the reset driver SD activates the potential Vrst of the reset line Lrst to the high level potential. Right after the activation, the scanning line driver SD raises the potential of the first scanning line Lscan[n]. As a result, the third power supply potential Vref is applied to the gate of the bias transistor Tbias via the reset transistor Trst and the Vt detection transistor Vdet. A potential of the node N1 is set to the third power supply potential Vref. The bias transistor Tbias turns conductive to thereby apply the potential of the second scanning line Lscan[n+1] to be selected next to the currently selected first scanning line Lscan[n] to the gate of the drive transistor Tdrv. That is, the second scanning line Lscan[n+1] in a negative potential state is connected to the gate (node N3) of the drive transistor Tdrv. As a result, a negative bias is applied to the gate of the drive transistor Tdrv and the threshold voltage of the drive transistor Tdrv is returned to the original threshold voltage Vth. In this way, by applying the negative bias to the gate of the drive transistor Tdrv, the threshold voltage of the drive transistor Tdrv falling when the light emitting element 21 is previously driven can be raised up to near the original threshold voltage Vth.

At t12, the reset driver SD reduces the potential Vrst of the reset line Lrst to the low level potential, thereby disconnecting the node N1 from the third power supply potential Vref. Thereafter, during a period from t12 to t13, the scanning line driver SD raises the potential Vscan[n+1] of the second scanning line Lscan[n+1]. The potential of the node N3 thereby rises to the high level potential according to the rising of the potential Vscan[n+1]. However, if the potential difference between the nodes N3 and N2 exceeds the threshold voltage Vth of the drive transistor Tdrv, the drive transistor Tdrv turns conductive. Accordingly, the node N1 is connected to the second power supply potential Vss and a gate potential of the bias transistor Tbias is set to the second power supply potential Vss via the Vt detection transistor Vdet. The bias transistor Tbias thereby turns nonconductive, so that the potential of the node N3 (potential of the first electrode of the capacitor Cap) is set to the threshold voltage Vth of the drive transistor Tdrv. Since the threshold voltage Vth of the drive transistor Tdrv is already recovered during a period from t11 to t12, the potential of the node N3 is set to the original threshold voltage Vth of the drive transistor Tdrv. Note that the high level potential of the second scanning line Lscan[n+1] needs to be higher than the threshold voltage Vth of the drive transistor Tdrv.

At t13, the scanning line driver SD reduces the potential Vscan[n] of the first scanning line Lscan[n]. By the falling of the potential Vscan[n], the Vt detection transistor Tdet and the scanning transistor Tscan turn nonconductive. Accordingly, the node N4 is kept in a state where a desired potential Vn is to the potential of the node N4. The desired potential Vn is potential data for driving the light emitting element 21 of the currently selected pixels PIXs to emit light at the desired brightness and the desired gradation. The potential Vn−1 is potential data applied to the pixels PIXs connected to the scanning line Lscan[n−1] selected prior to the scanning line Lscan[n]. A potential Vn+1 is potential data applied to the pixels PIXs connected to the scanning line Lscan[n+1] selected next to the scanning line Lscan[n].

The potential of the first electrode of the capacitor Cap (potential of the node N3) is kept Vn and the potential of the second electrode (potential of the node N4) is kept Vth. Namely, the potential difference held in the capacitor Cap is (Vth-Vn). The potential (Vth-Vn) held in the capacitor Cap is used to drive the light emitting element 21 to emit light.

Right after t13, the data line driver DD changes the potential Vdata of the data line Ldata from the desired potential Vn to the next potential Vn+1.

As can be seen, according to the first embodiment, the second scanning line Lscan[n+1] selected next to the currently selected first scanning line Lscan[n] is used. While the potential of the second scanning line Lscan[n+1] is the low level potential (negative bias), this negative bias is applied to the gate of the drive transistor Tdrv, thereby recovering the original threshold voltage Vth of the drive transistor Tdrv. When the potential of the second scanning line Lscan[n+1] rises to the high level potential next time, the threshold voltage Vth of the drive transistor Tdrv is detected.

Thereafter, at t14, the scanning line driver SD raises a potential of the signal Vems to the high level potential to thereby turn on the first and second switching elements Tems1 and Tems2. The node N4 is thereby connected to the node N2 and the potential difference between the gate and the source of the drive transistor Tdrv (potential difference between the nodes N2 and N3) becomes equal to (Vth+Vn). Further, the light emitting element 21 is connected to the drain of the drive transistor Tdrv. The drive transistor Tdrv thereby applies a current based on the potential (Vth+Vn) to the light emitting element 21. The light emitting element 21 emits light at the brightness and the gradation based on this current applied thereto.

According to the first embodiment, the negative bias of the second scanning line Lscan[n+1] can be applied to the gate of the drive transistor Tdrv. The display device according to the first embodiment can thereby return the shifted threshold voltage of the drive transistor Tdrv to the original threshold voltage (threshold voltage before shift) Vth. Moreover, according to the first embodiment, during transition of the potential of the second scanning line Lscan[n+1] from the low level potential to the high level potential, the threshold voltage Vth of the drive transistor Tdrv is set to the first electrode of the capacitor (node N3) using the potential rising of the second scanning line Lscan[n+1]. At this time, the desired data potential Vn is set to the second electrode of the capacitor Cap (node N4).

As can be understood, according to the first embodiment, the threshold voltage Vth of the drive transistor Tdrv can be recovered, a drain voltage of the drive transistor Tdrv can be reset, and the threshold voltage Vth of the drive transistor Tdrv can be quickly set to one end of the capacitor Cap using the scanning line Lscan[n+1] selected after the currently selected scanning line Lscan[n]. By applying the first embodiment to the active matrix display device, it is possible to realize a display device capable of maintaining stable display quality for long time and suitable for a large-sized, high-definition display.

The power supply potential Vref for resetting the potential Vems can be replaced by the first power supply potential Vdd.

### Second Embodiment

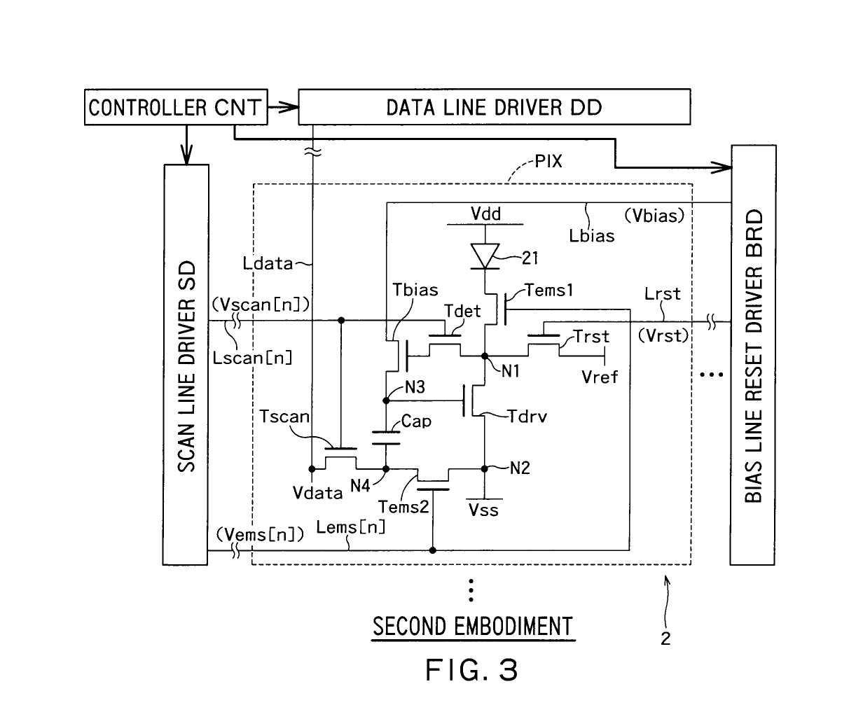

In a display device according to a second embodiment of the present invention shown in FIG. 3, a bias line and reset line driver BRD controls the reset transistor Trst and the negative bias is applied to the node N3 without using the second scanning line Lscan[n+1] selected next to the first scanning line Lscan[n].

The reset line Lrst is connected from the bias line and reset line driver BRD to the gate of the reset transistor Trst. The bias line and reset line driver BRD controls the reset transistor Trst via the reset line Lrst. The bias line Lbias is connected from the bias line and reset line driver BRD to a drain of the bias transistor Tbias. The bias line and reset line driver BRD applies the negative bias to the node N3 via the bias line Lbias or controls a potential of the bias line Lbias so as to raise the potential of the node N3 up to the threshold voltage Vth of the drive transistor Tdrv. The other configurations of the display device according to the second embodiment are similar to those of the display device according to the first embodiment.

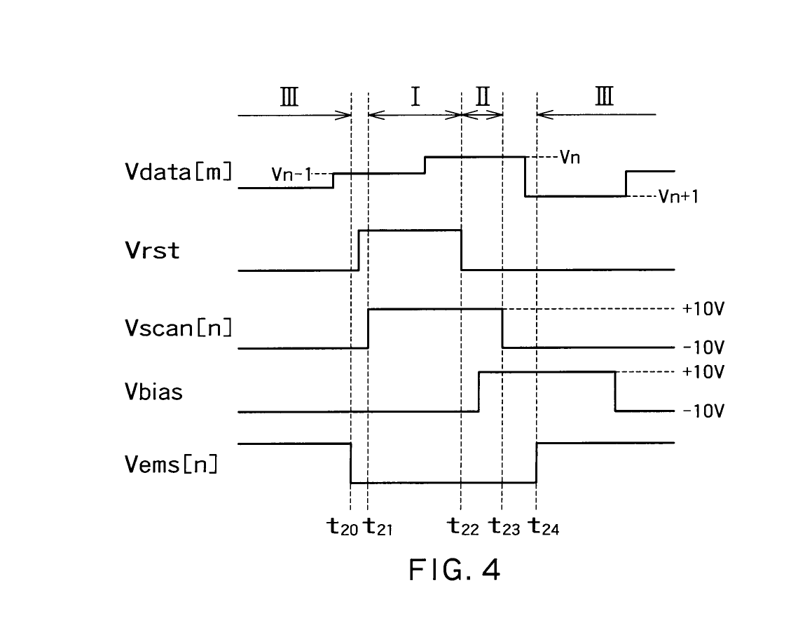

With reference to FIG. 4, an operation performed by the display device according to the second embodiment will be described. Before t20, the scanning line driver SD selects the scanning line Lscan[n−1]. At t20, the scanning line driver SD deactivates the potential Vems[n] of the switching line Lems[n] to the low level potential. Right after the deactivation, the bias line and reset line driver BSD raises the potential Vrst of the reset line Lrst to the high level potential. At t21, the scanning line driver SD raises the potential of the first scanning line Lscan[n]. The third power supply potential Vref is thereby applied to the gate of the bias transistor Tbias via the reset transistor Trst and the Vt detection transistor Tdet. The bias transistor Tbias turns conductive to apply the potential Vbias of the bias line Lbias to the gate of the drive transistor Tdrv. At this time, the bias line and reset line driver BSD outputs the negative bias as the bias potential Vbias. As a result, the threshold voltage of the drive transistor Tdrv is returned to the original threshold voltage Vth.

At t22, the bias line and reset line driver BSD reduces the potential Vrst of the reset line Lrst to the low level potential, thereby disconnecting the node N1 from the third power supply potential Vref. Thereafter, during a period from t22 to t23, the bias line and reset line driver BSD raises the potential Vbias of the bias line Lbias to a higher potential than the threshold voltage Vth of the drive transistor Tdrv. The potential of the node N3 is thereby set to the threshold voltage Vth of the drive transistor Tdrv. Since the threshold voltage Vth of the drive transistor Tdrv is already recovered during a period from t21 to t22, the potential of the node N3 is set to the original threshold voltage Vth of the drive transistor Tdrv.

At t23, the scanning line driver SD reduces the potential Vscan[n] of the first scanning line Lscan[n]. The potential Vn of the data line Ldata at this time is set to the node N4.

Thereafter, at t24, the scanning line driver SD raises the potential Vems of the switching line Lems. The drive transistor Tdrv thereby applies a current based on the potential difference (Vth+Vn) between the first and second electrodes of the capacitor Cap to the light emitting element 21. As a result, the light emitting element 21 emits light at a desired brightness and at a desired gradation. Since the more detailed light emitting operation performed by the light emitting element 21 is similar to that according to the first embodiment, it will not be described herein.

According to the second embodiment, the bias line and reset line driver BSD controls the potential of the reset line Lrst and that of the bias line Lbias without using the scanning lines Lscan[n+1] selected after the currently selected first scanning line Lscan[n]. Therefore, according to the second embodiment, rising/falling timing of the reset potential and that of the bias potential can be arbitrarily set despite need to additionally provide the bias line and reset line driver BSD. Accordingly, the second embodiment can attain the advantages of the first embodiment.

Moreover, the second embodiment can attain the advantages of recovering the threshold voltage Vth of the drive transistor Tdrv, resetting the drain voltage of the drive transistor Tdrv, and quickly setting the threshold voltage Vth of the drive transistor Tdrv to one end of the capacitor Cap similarly to the first embodiment. The third power supply potential Vref for resetting the potential Vems can be replaced by the first power supply potential Vdd.

In the first and second embodiments, the display element is the OLED. However, the display element according to the present invention is not limited to the OLED but an arbitrary current-driven light emitting element the luminous brightness of which changes according to a current value such as a charge-injection inorganic EL element or a charge-injection electrochemical light emitting element can be used as the display element. Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A display device including a pixel array including a plurality of display pixels including current-driven light emitting elements, comprising:
a plurality of scanning lines provided to correspond to pixel rows of the pixel array, respectively;
a plurality of data lines provided to correspond to pixel columns of the pixel array, respectively;
an N-type drive transistor controlling a current carried from a first power supply to a second power supply via the light emitting element;
a bias transistor connected between a gate of the drive transistor and a first signal line, the first signal line transmitting a negative bias lower than a potential of the second power supply;
a Vt detection transistor connected between a gate of the bias transistor and a drain of the drive transistor, and setting a threshold voltage of the drive transistor to the gate of the bias transistor;
a capacitor having a first electrode connected to the gate of the drive transistor, and applying a potential difference between the gate of the drive transistor and a source of the drive transistor when the light emitting element is driven to emit light;
a scanning transistor connected between a second electrode of the capacitor and the data line corresponding to a selected pixel column among the plurality of data lines, and setting a potential of the data line corresponding to the selected pixel column to the second electrode;
a scanning line driver applying a potential to the plurality of scanning lines and the first signal line; and
a data line driver transmitting potential data to the plurality of pixel columns via the plurality of data lines, respectively, the potential data for driving the light emitting element to emit the light at a desired brightness and at a desired gradation, wherein
before setting the threshold voltage to the first electrode, the bias transistor connects the first signal line to the gate of the drive transistor and applies the negative bias to the gate of the drive transistor.

2. The device according to claim 1, wherein
the scanning line driver sets the threshold voltage to the first electrode by raising a potential of the first electrode from the negative bias to a higher potential than the threshold voltage of the drive transistor, and
the scanning transistor connects the data line corresponding to the selected pixel column to the second electrode and sets the potential of the data line corresponding to the selected pixel column to the second electrode.

3. The device according to claim 1, further comprising:
a reset line activated when a potential of the drain of the driver transistor is reset;
a reset line driver applying a potential to the reset line; and
a reset transistor connected between the drain of the driver transistor and a third power supply, and having a gate connected to the reset line, wherein
a gate of the Vt detection transistor and a gate of the scanning transistor are connected to a first scanning line corresponding to a selected pixel row among the plurality of scanning lines,
the first signal line is a second scanning line selected next to the first scanning line among the plurality of scanning lines, and
when the bias transistor applies the negative bias to the gate of the drive transistor, the reset transistor resets the potential of the drain of the drive transistor to a potential of the third power supply.

4. The device according to claim 2, further comprising:
a reset line activated when a potential of the drain of the driver transistor is reset;
a reset line driver applying a potential to the reset line; and
a reset transistor connected between the drain of the driver transistor and a third power supply, and having a gate connected to the reset line, wherein
a gate of the Vt detection transistor and a gate of the scanning transistor are connected to a first scanning line corresponding to a selected pixel row among the plurality of scanning lines,
the first signal line is a second scanning line selected next to the first scanning line among the plurality of scanning lines, and
when the bias transistor applies the negative bias to the gate of the drive transistor, the reset transistor resets the potential of the drain of the drive transistor to a potential of the third power supply.

5. A display device including a pixel array including a plurality of display pixels including current-driven light emitting elements, comprising:
a plurality of scanning lines provided to correspond to pixel rows of the pixel array, respectively;
a plurality of data lines provided to correspond to pixel columns of the pixel array, respectively;
an N-type drive transistor controlling a current carried from a first power supply to a second power supply via the light emitting element;
a bias transistor connected between a gate of the drive transistor and a first signal line, the first signal line transmitting a negative bias lower than a potential of the second power supply;
a Vt detection transistor connected between a gate of the bias transistor and a drain of the drive transistor, and setting a threshold voltage of the drive transistor to the gate of the bias transistor;
a capacitor having a first electrode connected to the gate of the drive transistor, and applying a potential difference between the gate of the drive transistor and a source of the drive transistor when the light emitting element is driven to emit light;
a scanning transistor connected between a second electrode of the capacitor and the data line corresponding to a selected pixel column among the plurality of data lines, and setting a potential of the data line corresponding to the selected pixel column to the second electrode;
a scanning line driver applying a potential to the plurality of scanning lines;
a data line driver transmitting potential data to the plurality of pixel columns via the plurality of data lines, respectively, the potential data for driving the light emitting element to emit the light at a desired brightness and at a desired gradation;
a reset line activated when a potential of the drain of the driver transistor is reset;
a reset line driver applying a potential to the reset line and the first signal line; and
a reset transistor connected between the drain of the driver transistor and a first power supply, and resetting the potential of the drain of the driver transistor, wherein
before setting the threshold voltage to the first electrode, the bias transistor connects the first signal line to the gate of the drive transistor and applies the negative bias to the gate of the drive transistor, and
the reset line drive sets the threshold voltage to the first electrode by raising a potential of the first electrode from the negative bias to a higher potential than the threshold voltage of the drive transistor.

6. The device according to claim 5, wherein
a gate of the Vt detection transistor and a gate of the scanning transistor are connected to a first scanning line selecting display pixels among the plurality of scanning lines,
the reset transistor is driven by the reset line driver when the reset transistor resets the potential of the drain of the drive transistor, and
the reset line driver applies the negative bias to the gate of the drive transistor.

7. The device according to claim 1, wherein the drive transistor is an n-type amorphous silicon transistor having a channel part made of amorphous silicon.

8. The device according to claim 5, wherein the drive transistor is an n-type amorphous silicon transistor having a channel part made of amorphous silicon.

9. The device according to claim 1, further comprising:
a first switching element connected between the light emitting element and the drain of the drive transistor; and
a second switching element connected between the second electrode of the capacitor and a source of the drive transistor, wherein
the reset transistor and the Vt detection transistor are made conductive, and a potential of the first power supply is applied to the gate of the bias transistor to make the bias transistor conductive,
the bias transistor applies the negative bias to the gate of the drive transistor,
after making the reset transistor nonconductive, a potential of a first scanning line corresponding to a selected pixel row among the plurality of scanning lines is raised to a positive potential while keeping the Vt detection transistor conductive, and the threshold voltage of the drive transistor is set to the first electrode of the capacitor,
the potential data is set to the second electrode of the capacitor by making the scanning transistor conductive, and
after reducing the potential of the first scanning line, the first switching element and the second switching element are made conductive to apply a current to the display pixels by the drive transistor according to a potential difference held in the capacitor.

10. The device according to claim 5, further comprising:
a first switching element connected between the light emitting element and the drain of the drive transistor; and
a second switching element connected between the second electrode of the capacitor and a source of the drive transistor, wherein
the reset transistor and the Vt detection transistor are made conductive, and a potential of the first power supply is applied to the gate of the bias transistor to make the bias transistor conductive,
the bias transistor applies the negative bias to the gate of the drive transistor,
after making the reset transistor nonconductive, a potential of a first scanning line corresponding to a selected pixel row among the plurality of scanning lines is raised to a positive potential while keeping the Vt detection transistor conductive, and the threshold voltage of the drive transistor is set to the first electrode of the capacitor,
the potential data is set to the second electrode of the capacitor by making the scanning transistor conductive, and
after reducing the potential of the first scanning line, the first switching element and the second switching element are made conductive to apply a current to the display pixels by the drive transistor according to a potential difference held in the capacitor.

11. The device according to claim 1, wherein a low level potential of the first signal line is a potential of the negative bias, and a high level potential of the first scanning line is higher than the threshold voltage of the drive transistor.

12. The device according to claim 5, wherein a low level potential of the first signal line is a potential of the negative bias, and a high level potential of the first scanning line is higher than the threshold voltage of the drive transistor.

13. A method of driving a display device including a pixel array including a plurality of display pixels including current-driven light emitting elements,
the display device including:
a plurality of scanning lines provided to correspond to pixel rows of the pixel array, respectively;
a plurality of data lines provided to correspond to pixel columns of the pixel array, respectively;
an N-type drive transistor controlling a current carried from a first power supply to a second power supply via the light emitting element;
a bias transistor connected between a gate of the drive transistor and a first signal line, the first signal line transmitting a negative bias lower than a potential of the second power supply;
a Vt detection transistor connected between a gate of the bias transistor and a drain of the drive transistor;
a capacitor having a first electrode connected to the gate of the drive transistor;
a scanning transistor connected between a second electrode of the capacitor and the data line corresponding to a selected pixel column out of the plurality of data lines;
a scanning line driver applying a potential to the plurality of scanning lines and the first signal line; and
a data line driver transmitting potential data to the plurality of pixel columns via the plurality of data lines, respectively, the potential data for driving the light emitting element to emit the light at a desired brightness and at a desired gradation,
the method comprising:
connecting the first signal line to the gate of the drive transistor, and applying the negative bias to the gate of the drive transistor;
setting the threshold voltage to the first electrode by raising a potential of the first electrode from the negative bias to a higher potential than the threshold voltage of the drive transistor;
connecting the data line corresponding to the selected pixel column to the second electrode, and setting the potential of the data line corresponding to the selected pixel column to the second electrode; and
applying a current according to a potential difference between the first electrode and the second electrode of the capacitor to the light emitting element to drive the light emitting element to emit the light.

14. A method of driving a display device including a pixel array including a plurality of display pixels including current-driven light emitting elements,
the display device including:
a plurality of scanning lines provided to correspond to pixel rows of the pixel array, respectively;
a plurality of data lines provided to correspond to pixel columns of the pixel array, respectively;
an N-type drive transistor controlling a current carried from a first power supply to a second power supply via the light emitting element;
a bias transistor connected between a gate of the drive transistor and a first signal line, the first signal line transmitting a negative bias lower than a potential of the second power supply;
a Vt detection transistor connected between a gate of the bias transistor and a drain of the drive transistor;
a capacitor having a first electrode connected to the gate of the drive transistor;
a scanning transistor connected between a second electrode of the capacitor and the data line corresponding to a selected pixel column out of the plurality of data lines;
a scanning line driver applying a potential to the plurality of scanning lines;
a data line driver transmitting potential data to the plurality of pixel columns via the plurality of data lines, respectively, the potential data for driving the light emitting element to emit the light at a desired brightness and at a desired gradation;
a reset line activated when a potential of the drain of the driver transistor is reset;
a reset line driver applying a potential to the reset line and the first signal line; and
a reset transistor connected between the drain of the driver transistor and a first power supply, and resetting the potential of the drain of the driver transistor,
the method comprising:
connecting the first signal line to the gate of the drive transistor, and applying the negative bias to the gate of the drive transistor;
setting the threshold voltage to the first electrode by raising a potential of the first electrode from the negative bias to a higher potential than the threshold voltage of the drive transistor;
connecting the data line corresponding to the selected pixel column to the second electrode, and setting the potential of the data line corresponding to the selected pixel column to the second electrode; and
applying a current according to a potential difference between the first electrode and the second electrode of the capacitor to the light emitting element to drive the light emitting element to emit the light.
